(19) United States
(12) Patent Application Publication
(10) Pub. No.: US 2026/0366249 A1
(43) Pub. Date: Nov. 19, 2026

(54) A ROAD CLEANING VEHICLE

(71) Applicant: BUCHER MUNICIPAL LIMITED, Dorking Surrey (GB)

(72) Inventors: Gareth KNOPP, Dorking Surrey (GB); Ganindu NANAYAKKARA, Dorking Surrey (GB)

(21) Appl. No.: 19/121,884

(22) PCT Filed: Oct. 4, 2023
(86) PCT No.: PCT/GB2023/052563

§ 371 Date: Apr. 17, 2025

(30) Foreign Application Priority Data
Oct. 17, 2022 (GB) 2215294.6
Oct. 17, 2022 (GB) 2215298.7
Oct. 17, 2022 (GB) 2215310.0
Oct. 17, 2022 (GB) 2215311.8

(51) Int. Cl. E01H 1/08; B05B 13/00

(52) U.S. Cl. CPC E01H 1/08; B05B 13/005

(57) ABSTRACT

Disclosed is a driving system for driving the road cleaning vehicle along a road having debris, road cleaning equipment for cleaning the debris on the road, A control system including a controller and at least one debris sensor including at least one image camera for generating first and second debris sensor image data for identifying the type and location of debris in front of and behind the vehicle, the driving system and/or road cleaning equipment being operated by the controller based upon the location and type of debris identified in front of and behind the road cleaning vehicle to control the cleaning of debris on the road by the road cleaning vehicle.

### TECHNICAL FIELD

The present disclosure is directed towards a road cleaning vehicle and a method of operating such a road cleaning vehicle.

### BACKGROUND

Road cleaning vehicles (also referred to as road sweepers, street cleaners and the like) are commonly used to remove unwanted debris from streets. A typical road cleaning vehicle is disclosed in GB2591486A and comprises road cleaning equipment such as cleaning brushes for sweeping the road, a debris collection system for drawing from the road into a hopper mounted on the vehicle chassis and water jets for cleaning the road. An operator in a cab controls the travel of the vehicle in addition to controlling the function of the road cleaning equipment.

There is an increasing interest in alternative powered Rechargeable Energy Storage System (RESS) vehicles, such as electrical vehicles (i.e. vehicles which do not use an internal combustion engine to provide a driving force), including road cleaning vehicles operating by electrical power rather than internal combustion engines. In electrical road cleaning vehicles, the range of the vehicle is limited by the energy storage capacity of the system, such as a battery, and the efficiency of its components. There is therefore now a need to increase the efficiency of operation of road cleaning vehicles, particularly in the control of the road cleaning equipment.

Furthermore, the need to control the travel of the road cleaning vehicle in conjunction with the road cleaning equipment places a high cognitive load on the operator, as well as requiring them to repetitively perform tasks. This may increase the fatigue of the operator and reduce the cleaning effectiveness of using the road cleaning vehicle. In addition, the operator needs a high level of skill and experience to be able to identify the type of debris on the road ahead and selectively operate the road cleaning equipment efficiently.

WO2020/152526A1 discloses an automated road sweeper including a front facing video camera that scans the road ahead of the road sweeper to identify debris. The output from the video camera is used to select and exclusively operate the cleaning members covering a cleaning area in which the debris is located during movement of the sweeper. However, there is a continuing need to improve the efficiency and effectiveness of automated operation of all parts of the cleaning equipment.

A known issue is that an inlet nozzle of the debris collection equipment can become blocked. The nozzle must necessarily be close to the road to provide effective suction of debris into the hopper. However, as the nozzle is so close to the road, larger debris (i.e. debris larger than the gap between the nozzle and road) can become caught by the front of the nozzle and thus be dragged along the road, or pushed away from the collection means. Further debris builds up in front of the nozzle, reducing the effectiveness of the inlet nozzle, until an operator notices the problem and removes the built-up debris.

There is also currently a considerable focus on the reduction of atmospheric particulate matter (“PM”) concentrations, particularly in urban areas. PM deposited on roads is typically removed by the road cleaning vehicles using the water jets, which mix the PM with water for removal from the road by the collection means, such as a inlet nozzle. However, if the water jets are not switched on by the operator, or are in a sub-optimal configuration, the PM can be disturbed and raised into the atmosphere. Such water jets include those within the system, such as in the inlet tubes or hopper, which reduce “carry over”, being when dust goes through the fan system and out of the outlet into the atmosphere.

### SUMMARY

An object of the present disclosure is to provide a road cleaning vehicle with improved efficiency and effectiveness of operation of the road cleaning equipment, such as by avoiding bulldozing over debris or unintentionally pushing such debris away from the road cleaning equipment and collection means. A further object of the present disclosure is to provide a road cleaning vehicle with reduced tendency to exhibit a blockage of the inlet nozzle. A further object of the present disclosure is to provide a road cleaning vehicle with increased collection, entrainment and entrapment of PM, which can improve air quality.

The present invention provides a road cleaning vehicle comprising: a driving system for driving the road cleaning vehicle along a road having debris thereon; road cleaning equipment for cleaning the debris on the road; and a control system comprising: at least one debris sensor configured for generating first debris sensor data for locating debris on the road in front of the road cleaning vehicle and second debris sensor data for locating debris on the road behind the road cleaning vehicle; and a controller configured to: receive first and second debris sensor data from the at least one debris sensor; process the first debris sensor data in a debris identification model to identify debris in front of the road cleaning vehicle and process the second debris sensor data in the debris identification model to identify any debris behind the road cleaning vehicle; and operate the driving system and/or road cleaning equipment based upon debris identified in front of and behind the road cleaning vehicle to control the cleaning of debris on the road by the road cleaning vehicle.

The controller may be configured to process the first debris sensor data in a debris identification model to identify debris in front of the road cleaning vehicle, such as the location of debris. The controller may be configured to operate the driving system and/or road cleaning equipment based upon debris identified in front of the road cleaning vehicle to control the cleaning of debris on the road by the road cleaning vehicle, such as operating the road cleaning equipment and/or steering the vehicle to collect and/or clean the debris. The controller may be configured to process the second debris sensor data in the debris identification model to identify debris behind of the road cleaning vehicle, such as debris erroneously not collected by the road cleaning equipment. The controller may be configured to operate the driving system and/or road cleaning equipment based upon the debris identified behind the road cleaning vehicle to control the cleaning of debris on the road by the road cleaning vehicle, such as by adjusting the road cleaning equipment and/or steering the vehicle to avoid further debris erroneously not being collected and/or by adjusting a vehicle control strategy and/or debris identification model so as to avoid further debris erroneously not being collected during future cleaning.

The at least one debris sensor may comprise a first debris sensor configured for generating first debris sensor data for locating debris on the road in front of the road cleaning vehicle and a second debris sensor configured for generating second debris sensor data for locating debris on the road behind the road cleaning vehicle. The controller may be configured to operate the driving system and/or road cleaning equipment based upon the debris identified in front of the road cleaning vehicle using a vehicle cleaning control strategy. The controller may be configured to operate the driving system and/or road cleaning equipment, using the vehicle cleaning control strategy, also based upon the location of the vehicle and debris map data, environmental objects around the vehicle and/or a determined trajectory of the vehicle.

The controller may be configured to operate the driving system and/or road cleaning equipment based upon the debris identified behind the road cleaning vehicle by: using the vehicle cleaning control strategy; and/or updating the vehicle cleaning control strategy and/or debris identification model based upon the debris identified behind the road cleaning vehicle. The vehicle cleaning control strategy and/or debris identification model may be updated based upon a comparison of the debris identified in front of and behind the road cleaning vehicle.

The road cleaning vehicle may further comprise an alert system for providing information to an operator and the controller may be further configured to: determine an alert status based upon the debris identified in front of and behind the road cleaning vehicle; and operate the alert system to generate an alert indicative of the alert status for the operator. The controller may be configured to monitor an adjustment of the operational settings of the driving system and/or road cleaning equipment by the operator and subsequently update the vehicle cleaning control strategy and/or debris identification model based upon the adjustment of the operational settings by the operator.

The at least one debris sensor may comprise at least one of a camera, a 2D image camera, a 3D image camera, a monocular camera, an event camera, an infrared camera, a stereovision camera, lidar and/or a proximity sensor.

The first debris sensor may be configured to capture sensor data for locating debris in a first scanning area of the road in front of the vehicle and the second debris sensor may be configured to capture sensor data for locating debris in a second scanning area of the road behind the road cleaning vehicle. The road cleaning vehicle may comprise a cab and the first debris sensor may be mounted to, adjacent to or in the cab and/or the road cleaning vehicle comprises a hopper and the second debris sensor may be mounted to, adjacent to or in the hopper.

The road cleaning equipment may comprise at least a pair of brushes for cleaning the road and the controller may be configured to: process the second debris sensor data in the debris identification model to identify a line of uncleaned debris along the road behind the vehicle resulting from a gap between the brushes from the debris identified behind the road cleaning vehicle; and operate the driving system and/or road cleaning equipment based upon debris identified in front of and behind the road cleaning vehicle to control the cleaning of debris on the road by the road cleaning vehicle by operating at least the pair of brushes to close the gap between them so as to prevent the road cleaning vehicle from leaving the line of uncleaned debris.

The present invention further provides a method of operating a road cleaning vehicle comprising, at the controller: receiving the first and second debris sensor data from the at least one debris sensor; processing the first debris sensor data in a debris identification model to identify debris in front of the road cleaning vehicle and process the second debris sensor data in the debris identification model to identify any debris behind the road cleaning vehicle; and operating the driving system and/or road cleaning equipment based upon the debris identified in front of and behind the road cleaning vehicle to control the cleaning of debris on the road by the road cleaning vehicle.

The present invention therefore provides, in combination with or alternatively to the aforementioned vehicle(s), a road cleaning vehicle comprising: a driving system for driving the road cleaning vehicle along a road having debris thereon; a road cleaning equipment for cleaning the debris on the road; and a control system comprising: at least one particulate matter (PM) sensor for generating PM data indicative of PM concentrations in the atmosphere adjacent to the vehicle; and a controller configured to: receive the PM data from the PM sensor; process the PM data to determine atmospheric PM concentrations resulting from the operation of the road cleaning equipment; and operate the road cleaning equipment and/or driving system based upon the determined atmospheric PM concentrations and/or operate an alert system of the road cleaning vehicle to alert the operator to the determined atmospheric PM concentrations.

The present invention further provides a road cleaning vehicle comprising: a driving system for driving the road cleaning vehicle along a road having debris thereon; a road cleaning equipment for cleaning the debris on the road; and a control system comprising: a first PM sensor located behind, relative to the forward direction of movement of the vehicle, at least part of the road cleaning equipment, for generating first PM data indicative of PM concentrations in the atmosphere including those resulting from the operation of the road cleaning equipment; and a second PM sensor located in front of, relative to the forward direction of movement of the vehicle, at least part of the road cleaning equipment, for generating second PM data indicative of PM concentrations in the atmosphere prior to any PM concentration contributions from the road cleaning equipment; and a controller configured to: receive the first and second PM data from the first and second PM sensor; and process the first and second PM data to determine atmospheric PM concentrations resulting from the operation of the road cleaning equipment by comparing PM concentrations determined by the first PM sensor with PM concentrations determined by the second PM sensor.

The controller may be configured to process the PM data to determine atmospheric PM concentrations resulting from the operation of the road cleaning equipment by comparing the PM data with baseline PM concentrations received at the controller from a remote computer system. The baseline PM concentration may be indicative of local atmospheric PM concentrations.

The control system may comprise a first PM sensor located behind, relative to the forward direction of movement of the vehicle, at least part of the road cleaning equipment. The control system may comprise a second PM sensor located in front of, relative to the forward direction of movement of the vehicle, at least part of the road cleaning equipment. The controller may be configured to process the PM data to determine atmospheric PM concentrations resulting from the operation of the road cleaning equipment by comparing PM concentrations determined by the first PM sensor with PM concentrations determined by the second PM sensor.

The controller may be configured to operate the alert system to alert the operator if the atmospheric PM concentrations reach a concentration threshold. The controller may be configured to operate the road cleaning equipment and/or driving system based upon the determined atmospheric PM concentrations by adjusting the operational settings of the driving system and/or road cleaning equipment in order to avoid exceeding the PM concentration(s) threshold value or range. When the determined atmospheric PM concentrations are below a PM concentration threshold value, a range of values may be determined for the operational settings to pick up the debris and the operational settings are set within the appropriate range, with a substantial margin beyond a base operational setting that is deemed to be suitable to pick up the specified debris. When the PM concentrations are above the PM concentration threshold value, weightings may be applied to at least one of the operational settings to reduce the margin beyond the base operational setting to maintain the PM concentration(s) below a threshold value or range.

The road cleaning equipment may comprise a cleaning fluid system for supplying cleaning fluid to the road and the controller may be configured to operate the cleaning fluid system to increase the supply of cleaning fluid to the road if the determined PM concentrations reach a concentration threshold. When the determined atmospheric PM concentrations are below a PM concentration threshold value, the amount of cleaning fluid applied may be maintained within a predetermined fluid application rate or application period in order to avoid running out of cleaning fluid over a specified operational time period of the vehicle.

When the PM concentrations are above the PM concentration threshold value, the application of cleaning fluid may be increased above the predetermined fluid application rate or period in order to reduce PM concentrations.

The control system may comprise at least one debris sensor configured to locate debris on the road in front of and/or behind the road cleaning vehicle when moving in the forward direction. The controller may be configured to receive debris sensor data from the at least one debris sensor. The controller may be configured to process the debris sensor data in a debris identification model to identify PM debris in front of and/or behind the road cleaning vehicle. The controller may be configured to operate the driving system and/or road cleaning equipment, in accordance with a vehicle cleaning control strategy, based upon PM debris identified in front of and/or behind the road cleaning vehicle to capture the PM debris.

The controller may be configured to, based upon the determined atmospheric PM concentrations resulting from the operation of the road cleaning equipment, operate the road cleaning equipment and/or driving system based upon the determined atmospheric PM concentrations and/or operate an alert system of the road cleaning vehicle to alert the operator to the determined atmospheric PM concentrations.

The control system may comprise at least one debris sensor configured to locate debris on the road in front of and/or behind the road cleaning vehicle when moving in the forward direction. The controller may be configured to receive debris sensor data from the at least one debris sensor. The controller may be configured to process the debris sensor data in a debris identification model to identify PM debris in front of and/or behind the road cleaning vehicle. The controller may be configured to operate the driving system and/or road cleaning equipment, in accordance with a vehicle cleaning control strategy, based upon PM debris identified in front of and/or behind the road cleaning vehicle to capture the PM debris.

The present invention further provides a method of operating a road cleaning vehicle comprising, at a controller: receiving PM data from a PM sensor; processing the PM data to determine atmospheric PM concentrations resulting from the operation of road cleaning equipment; and operating the road cleaning equipment and/or a driving system based upon the determined atmospheric PM concentrations and/or operate an alert system of the road cleaning vehicle to alert the operator to the determined atmospheric PM concentrations.

The present invention further provides in combination with or alternatively to the aforementioned method(s), a method of operating a road cleaning vehicle comprising: operating the road cleaning vehicle to move in a forward direction with a first PM sensor located behind at least part of road cleaning equipment and with a second PM sensor located in front of at least part of the road cleaning equipment; by the first PM sensor, generating first PM data indicative of PM concentrations in the atmosphere including those resulting from the operation of the road cleaning equipment; by the second PM sensor, generating second PM data indicative of PM concentrations in the atmosphere prior to any PM concentration contributions from the road cleaning equipment; and by the controller: receiving the first and second PM data from the first and second PM sensor; and processing the first and second PM data to determine atmospheric PM concentrations resulting from the operation of the road cleaning equipment by comparing PM concentrations determined by the first PM sensor with PM concentrations determined by the second PM sensor.

The present invention provides, in combination with or alternatively to the aforementioned vehicle(s), a road cleaning vehicle comprising: a driving system for driving the road cleaning vehicle along a road having debris thereon; road cleaning equipment for cleaning the debris on the road; a navigation system for determining a spatial location of the vehicle; and a control system comprising a controller configured to: determine the location and/or trajectory of the vehicle via the navigation system; receive debris map data indicative of at least one debris state associated with at least one predetermined location; determine from the location and/or trajectory and the debris map data that the vehicle is approaching and/or is at least partially in the at least one predetermined location; and operate the driving system and/or road cleaning equipment, as the vehicle travels at least partially over the at least one predetermined location, based upon the at least one debris state associated with the at least one predetermined location.

The debris map data may be representative of debris around a region and/or the at least one debris state comprises the type, amount and/or other properties of debris that is either known to be or has historically been found at the at least one predetermined location.

The vehicle may comprise at least one debris sensor for generating debris sensor data for locating debris on the road around the road cleaning vehicle. The debris data may subsequently being utilised in updating the at least one debris state associated with at least one predetermined location in the debris map data. The vehicle may further comprise at least one first debris sensor configured for generating first debris sensor data for locating debris on the road in front of the road cleaning vehicle, wherein the controller may be configured to: compare the first debris data with the at least one debris state so as to assess whether the at least one debris state is accurate for at least one predetermined location; and based upon such comparison, determine whether to operate the driving system and/or road cleaning equipment, as the vehicle travels at least partially over the at least one predetermined location, based upon first debris data and/or the at least one debris state associated with the at least one predetermined location.

The debris map data may include an indication of historical cleaning effectiveness at the predetermined location and the controller may be configured to operate the driving system and/or road cleaning equipment, as the vehicle travels at least partially over the at least one predetermined location, based upon the historical cleaning effectiveness to control the cleaning of debris on the road by the road cleaning vehicle.

The present invention further provides, in combination with or alternatively to the aforementioned method(s), a method of operating the road cleaning vehicle comprising, at the controller: determining the location and/or trajectory of the vehicle via the navigation system; receiving debris map data indicative of at least one debris state associated with at least one predetermined location; determining from the location and/or trajectory and the debris map data that the vehicle is approaching and/or is at least partially in the at least one predetermined location; and operating the driving system and/or road cleaning equipment, as the vehicle travels at least partially over the at least one predetermined location, based upon the at least one debris state associated with the at least one predetermined location.

The present invention provides, in combination with or alternatively to the aforementioned vehicle(s), a road cleaning vehicle comprising: a driving system for driving the road cleaning vehicle along a road having debris thereon; road cleaning equipment for cleaning the debris on the road; and a control system comprising: at least one first debris sensor configured to generate first debris sensor data for locating debris on the road in front of the road cleaning vehicle; and a controller configured to: receive first debris sensor data from the first debris sensor; process the first debris sensor data in a debris identification model to identify debris in front of the road cleaning vehicle and estimate the mass and/or volume of the debris in front of the road cleaning vehicle; and operate the driving system and/or road cleaning equipment based upon the estimated mass and/or volume of the debris identified in front of the road cleaning vehicle to control the cleaning of debris on the road by the road cleaning vehicle.

The controller may be configured to operate the driving system and/or road cleaning equipment based upon the estimated mass and/or volume of the debris identified in front of the road cleaning vehicle using a vehicle cleaning control strategy. The vehicle cleaning control strategy may link the estimated mass and/or volume of the debris identified in front of the vehicle to operational settings of the driving system and/or road cleaning equipment.

The road cleaning equipment may comprises a debris collection system comprising a fan for drawing air and debris through at least one inlet nozzle adjacent to the road. The controller may be configured to operate the debris collection system to control a suction pressure through the at least one inlet nozzle based upon the estimated mass and/or volume of the debris identified in front of the road cleaning vehicle.

The controller may be configured to, if the estimated mass and/or volume is relatively high, implement a high fan speed or, if the estimated mass and/or volume is relatively low, implement a lower fan speed.

The road cleaning equipment may comprise a cleaning fluid system. The controller may be configured to operate the debris collection system to control the application of fluid by the cleaning fluid system based upon the estimated mass and/or volume of the debris identified in front of the road cleaning vehicle.

The controller may be configured to determine if a mass to volume ratio of debris is below a threshold ratio. If the mass to volume ratio of debris is below the threshold ratio, the controller may identify the presence of particulate matter and operate cleaning fluid system 30 to supply fluid above a predetermined fluid supply level to clean the particulate matter.

The controller may be configured to process the first debris sensor data in the debris identification model to identify debris in front of the road cleaning vehicle. The controller may be configured to allocate the debris to at least one of a plurality of collection classifications, each collection classification having a mass and/or volume estimate associated therewith. The mass and/or volume of the debris in front of the road cleaning vehicle may be estimated based upon the collection classification to which the debris has been allocated.

The present invention further provides, in combination with or alternatively to the aforementioned method(s), a method of operating a road cleaning vehicle comprising, at a controller: receiving first debris sensor data from a first debris sensor; processing the first debris sensor data in a debris identification model to identify debris in front of the road cleaning vehicle and estimate the mass and/or volume of the debris in front of the road cleaning vehicle; and operate a driving system and/or road cleaning equipment based upon the estimated mass and/or volume of the debris identified in front of the road cleaning vehicle to control the cleaning of debris on a road by the road cleaning vehicle.

### BRIEF DESCRIPTION OF THE DRAWINGS

By way of example only, embodiments of a road cleaning vehicle and a method of operating such a vehicle in accordance with the present disclosure are now described with reference to, and as shown in, the accompanying drawings, in which:

FIG. 1 is a side elevation view of a road cleaning vehicle in accordance with the present disclosure;

FIG. 2 is a schematic of a control system of the vehicle of FIG. 1;

FIG. 3 is a schematic of a method of utilising data from first and second debris sensors of the vehicle of FIG. 1;

FIG. 4 is a top view of the vehicle of FIG. 1 showing a particular use of the method of FIG. 3;

FIG. 5 is a magnified side elevation view of the vehicle of FIG. 1;

FIG. 6 is a schematic of a method of utilising data from a debris accumulation sensor of the vehicle of FIG. 1; and

FIG. 7 is a schematic of a method of utilising data from a particulate sensor of the vehicle of FIG. 1.

### DETAILED DESCRIPTION

The present disclosure relates to a road cleaning machine including a plurality of sensors for automating the function of its road cleaning equipment. Front and rear facing sensors may be utilised to determine the effectiveness of the road cleaning equipment and adjust its used accordingly. The road cleaning equipment may be operated based upon an estimated mass and/or volume of debris in front of the vehicle. Blockages of a debris collection system, such as an inlet nozzle, of the road cleaning equipment may be effectively identified and removed using a debris accumulation sensor. PM thrown up by the vehicle may be detected by a particle sensor and the vehicle operation altered accordingly.

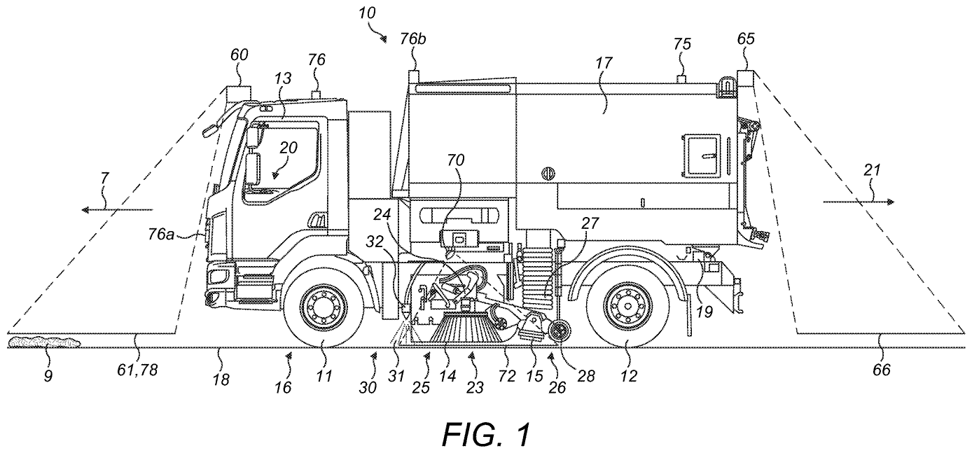

Road cleaning vehicles are commonly used to remove unwanted debris from streets. A road cleaning vehicle 10 in accordance with the present disclosure is shown in FIG. 1. The road cleaning vehicle 10 in this instance is a two axled truck mounted sweeper 10 in the form of a driver operated vehicle and may be referred to as a road and/or street sweeper and/or cleaner. The vehicle 10 is for cleaning roads outdoors, preferably cleaning across a width of at least about 1000 mm, 2000 mm or 3000 mm in a single pass.

The vehicle 10 comprises an operator control station 20 for a human operator to use to control the road cleaning vehicle 10. The operator control station 20 may comprise at least one operator input 47, such as a steering wheel, buttons, levers, accelerator pedal, touchscreen or the like, for the operator to use to control the vehicle 10 (also known as a Human Machine Interface or HMI). The operator control station 20 may be located in an operator cab 13 in which a human operator can travel towards or at the front of the vehicle 10. The vehicle 10 may further comprise an alert system 48 for providing output and/or information to the operator. The alert system 48 may be located in the cab 13 and may form part of the operator control station 20. The alert system 48 may comprise a display, lights, dials or the like for displaying information to the operator. The alert system 48 may be controllable by the at least one operator input 47.

The vehicle 10 further comprises a chassis 19 to which the operator cab 13 and a debris container or hopper 17 may be mounted.

The vehicle 10 comprises a driving system 16 for driving the road cleaning vehicle 10 in a forward direction 7 along a road 18 having debris 9 thereon. The road cleaning vehicle 10 may also be operable travel in a rearward direction 21 and to perform road cleaning functions in the rearward direction 21. The terms “front” and “rear” in the present disclosure refer to the forwardmost and rearward most parts respectively of the vehicle 10 when travelling in forward direction 7.

The driving system 16 comprises a power system (not shown), which may be a RESS, and may comprise a Rechargeable Energy Storage System (RESS) and motor(s) and/or internal combustion engine and transmission. The power system is for driving the vehicle 10, such as by driving front and rear wheels 11, 12. The driving system 16 further comprises a steering system (not shown) for controlling the direction of the vehicle 10 along the road 18. The driving system 16 may be controlled by the operator via the operator control station 20.

The vehicle 10 further comprises road cleaning equipment 25 for cleaning the debris 9 on and/or from the road 18. The road cleaning equipment 25 may comprise at least one cleaning brush 14 for brushing the road 18, such as a pair of brushes 14, which may each be located on both outer sides of the vehicle 10 (only one is illustrated in FIG. 1). Alternatively, the road cleaning equipment 25 may comprise a plurality of brushes 14 on each side of the vehicle 10. The at least one cleaning brush 14 may be operable to perform brush functions such as rotating, raising from and lowering to the road 18 and/or tilting at differing angles relative to the road 18. The road cleaning equipment 25 may comprise a brush system 23 comprising the at least one cleaning brush 14 mounted to the chassis 19 by at least one brush mount 24. The at least one brush mount 24 may be configured to operate the at least one cleaning brush 14 to perform the brush functions, such as by comprising appropriate motors, actuators, servos and/or the like. The cleaning function of the brushes 14 is supported by the action of being able to apply pressure to the substrate with a selectable variable force.

The road cleaning equipment 25 may comprise a debris collection system 26 for picking up debris 9 from the road 18 and delivering it to the hopper 17. The debris collection system 26 comprises at least one inlet nozzle 15 and/or mechanical collection system, such as a vacuum airflow support mechanical elevator. The inlet nozzle 15 may in particular be a suction inlet nozzle 15 through which air and debris 9 is drawn.

The inlet nozzle 15 may be connected by at least one inlet conduit 27 to the hopper 17 and may comprise a inlet nozzle 15 and inlet conduit 27 on either side of the vehicle 10. The suction force in the conduits is provided by a fan of the debris collection system 26 that draws air and debris 9 through the at least one inlet nozzle 15 and is arranged to create a negative pressure in the hopper 17. The conveyancing force draws the debris 9 from the road 18, through the at least one inlet nozzle 15, through the at least one inlet conduit 27 and into the hopper 17. Once in the hopper 17, the debris 9 is separated from the air by means of a separation system before the air is exhausted by the centrifugal fan assembly to the atmosphere.

The at least one inlet nozzle 15 may be configured to perform inlet nozzle functions, such as being raised from and lowered to the road 18 and/or tilting at differing angles relative to the road 18. FIG. 1 illustrates the at least one inlet nozzle 15 tilted backwardly so as to have a larger opening between the at least one inlet nozzle 15 and road 18 at the front of the at least one inlet nozzle 15 rather than its rear, thereby improving debris collection. The debris collection system 26 may comprises at least one inlet nozzle mount 28 mounting the least one inlet nozzle 15 to the chassis 19, vehicle 10 and/or hopper 17. The at least one inlet nozzle mount 28 may be configured to operate the at least one inlet nozzle 15 to perform the inlet nozzle functions, such as tilting and raising/lowering and may thus comprise appropriate motors, actuators, servos and/or the like.

The road cleaning equipment 25 may comprise a cleaning fluid system 30 for supplying cleaning fluid 31 to the road 18, to the vehicle 10 and/or within the vehicle 10, such as in a jet, spray and/or mist. The cleaning fluid 31 serves several functions, including as (a) a cleaning/wetting agent for the debris 9, (b) as lubrication within the debris collection system 26, such as to the at least one inlet conduit 27, to reduce both agglomeration of dirt and wear from erosion, and (c) as an atomised spray to attach to particulate matter (PM) and entrain it, thus adding mass to the particles which allows them to be separated from the airstream and be retained inside the hopper 17, thereby avoiding carryover through the fan and out into the atmospheric air.

The cleaning fluid 31 may be water, which may be stored in a tank mounted to the chassis 19. The cleaning fluid system 30 may be configured to supply the cleaning fluid 31 to the road 18 at or adjacent to the at least one brush 14, such as between the front wheel 11 and at least one brush 14, as illustrated. The cleaning fluid system 30 may additionally or alternatively be located at the front of the vehicle 10, i.e. in front of the front wheel 11, and/or at the rear of the vehicle 10, i.e. behind the rear wheel 12. The cleaning fluid system 30 may comprise at least one fluid supplier 32 (preferably a fluid supplier 32 on either side of the vehicle 10) directing cleaning fluid 31 at the road 18 as illustrated or, alternatively, may comprise an elongate bar extending across the width of the vehicle 10 for supplying a wide spray of cleaning fluid 31 across the vehicle 10. The fluid supplier 32 may be a nozzle, wand, bar or the like. The cleaning fluid system 30 may comprise a pump, valves and associated control systems (not shown) for controlling the supply of cleaning fluid 31.

The cleaning fluid system 30 may further comprise fluid suppliers or other supply means within the debris collection system 26, such as between the at least one inlet nozzle 15 and the hopper 17. Such internal fluid supplies are known as “PM10” jets and are commonly used to prevent carry over.

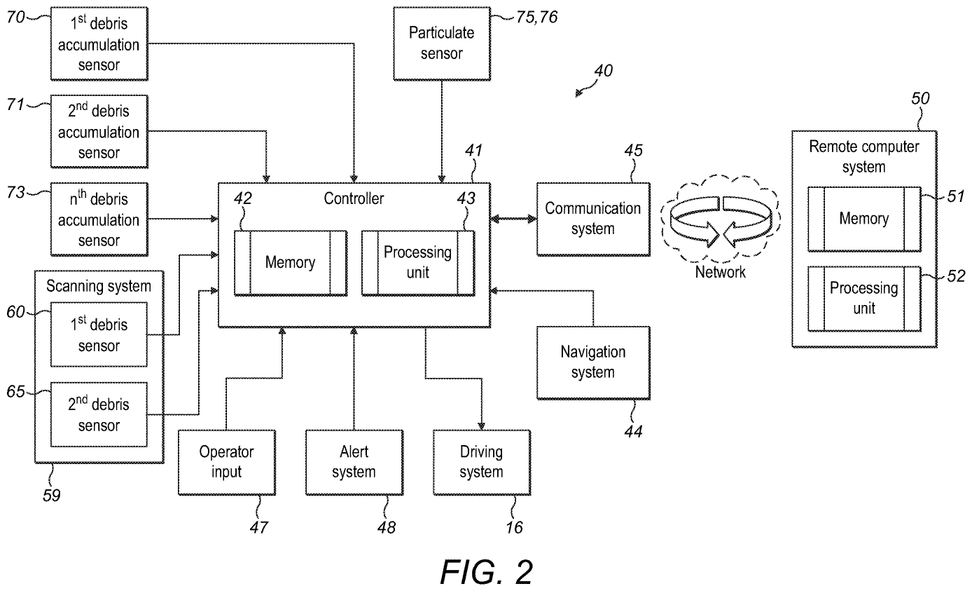

The vehicle 10 further comprises a control system 40, which is further illustrated in FIG. 2. The control system 40 comprises a controller 41 for controlling the various parts of the vehicle 10. The controller 41 may be of any suitable known type and may comprise an engine control unit (ECU) or the like. The controller 41 may comprise multiple control units, such as an ECU, auxiliary ECU(s) or control unit(s), artificial intelligence control unit(s) possibly with effective parallel computing capabilities and the like. Generally, the controller 41 may comprise a memory 42 (e.g. multiple memories on different control units), which may store instructions or algorithms in the form of data, and a processing unit 43 (e.g. multiple processing units on different control units), which may be configured to perform operations based upon the instructions. The memory 42 may comprise one or more suitable computer-accessible or non-transitory storage mediums for storing computer program instructions, such as RAM, SDRAM, DDR SDRAM, RDRAM, SRAM, ROM, magnetic media, optical media and the like. The processing unit 43 may comprise one or more suitable processors capable of executing memory-stored instructions, such as a microprocessor, uniprocessor, a multiprocessor, a tensor processing unit (TPU) for machine learning and the like. The controller 41 may further comprise one or more graphics or tensor processing units (e.g. multiple graphics processing units on different control units) for rendering objects for viewing on a display and any other computing system equipment required for performing the functions of the vehicle 10.

The controller 41 may be communicatively connected (via a wired or wireless connection) to and/or exchange data with the at least one operator input 47, the operator control station 20, the alert system 48, the driving system 16, the road cleaning equipment 25, a navigation system 44, a communication system 45 and/or at least one sensor 60, 65, 70, 71, 73, 75. The controller 41 may receive data, such as from the at least one operator input 47, navigation system 44, communication system 45 and at least one sensor 60, 65, 70, 71, 73, 75, process the data to determine instructions and then perform operations based upon the instructions, such as by sending data to the alert system 48, driving system 16, road cleaning equipment 25 and/or communication system 45, performing calculations or carrying out logic-based tasks when doing so.

The control system 40 may comprise the communication system 45 for transferring data between the control system 40 and a remote computer system 50. The communication system 45 may comprise any type suitable apparatus for communication therebetween, particularly a wireless network. Exemplary wireless networks include a satellite communication network, broadband communication network, cellular, Bluetooth, microwave, point-to-point wireless, point-to-multipoint wireless, multipoint-to-multipoint wireless, Wireless Local Service (WiFi Dongle), Dedicated Short-Range Communications (DSRC) or any other wireless communication network. The remote computer system 50 may comprise a remote computer system memory 51 and remote computer system processing unit 52 and may, for example, be under the control of the owner or manufacturer of the vehicle 10.

The control system 40 may comprise the navigation system 44 for determining the position and/or pose (i.e. the current position of the vehicle 10 and its local pose relative to the local reference frame of the vehicle or the local map) of the vehicle 10. The navigation system 44 may determine the location of the vehicle 10 on the Earth's surface and/or may determine the location of the vehicle 10 relative to a reference position. The navigation system 44 may comprise any suitable navigation system 44, such as by determining the position of the vehicle 10 via a global navigation satellite system, such as global positioning system (GPS), or via triangulation with communication masts. The navigation system 44 may determine the location of the vehicle 10 by having an onboard map that may be interpreted with onboard sensors such as inertial navigation equipment to determine the current position of the vehicle 10 within the map. This could also be used to navigate the vehicle 10 to a different position within the map.

The controller 41 may be operable to control the driving system 16 to control the vehicle 10 speed and/or the direction of travel of the vehicle 10, such as by controlling the power system and/or steering system.

The controller 41 may be operable to control the road cleaning equipment 25 to control the cleaning of the road 18 by the vehicle 10. The controller 41 may be operable to control the brush system 23, such as the at least one cleaning brush 14 and/or at least one brush mount 24, to perform the brush functions. The controller 41 may be operable to control the debris collection system 26, such as the at least one inlet nozzle mount 28 and/or at least one inlet nozzle 15, to perform the inlet nozzle functions. The controller 41 may be operable to control the cleaning fluid system 30, such as the at least one fluid supplier 32 and pump, to control the supply of cleaning fluid 31 to the road 18.

The control system 40 may comprise a scanning system 59 for scanning the road 18 and for identifying debris 9 on the road 18. The scanning system 59 may comprise at least one first debris sensor 60 configured for generating first debris sensor data for locating debris 9 on the road 18 in front of the vehicle 10 when moving in the forward direction 7 and/or at least one second debris sensor 65 configured for generating second debris sensor data for locating debris 9 on the road 18 behind the vehicle 10 when moving in the forward direction 7. The first and second debris sensors 60, 65 may be configured to generate the first and/or second debris sensor data relating to first and second scanning areas 61, 66 of the road 18 in front of and behind the vehicle 10 respectively. The first and second debris sensor data may be for identifying and/or locating debris 9 in the first and second scanning areas 61, 66, such as via processing of the sensor data in the controller 41.

In the present disclosure, the first and second debris sensors 60, 65 may be separate sensors or may be a single sensor (e.g. 360 degree camera), which may generate data in respect of an area covering both the first and second scanning areas 61, 66 together. Fundamentally, whether single or separate, the first and second debris sensors 60, 65 are capable of generating first and second debris sensor data in respect of the first and second scanning areas 61, 66 in front of and behind the vehicle 10.

The first and second scanning areas 61, 66 may be at least as wide as the vehicle 10 and may be up to twice or three times the width of the vehicle 10. The first and second scanning areas 61, 66 may extend along the road 18 away from the vehicle 10 by at least a quarter of the length of the vehicle 10 and optionally up to two times the length of the vehicle 10. The first and second scanning areas 61, 66 may be separated from the vehicle 10 (i.e. the first and second debris sensors 60, 65 do not generate sensor data relating to the road 18 adjacent to or at the front or rear of the vehicle 10). The first and second scanning areas 61, 66 may be indicative of the effective cleaning area of the vehicle 10, (e.g. the possible swept space with reference to the path and location of the vehicle 10). The effective cleaning area may be the local area within which the vehicle 10 can effect a change in the cleanliness level of the surrounding environment and scanned area. This would enable an effective measure of the cleaning performance of the vehicle 10 by distinguishing between what the vehicle 10 can and cannot change within these boundaries.

The first debris sensor 60 may be mounted at or towards the front of the vehicle 10 and may be directed downwards towards the road 18. The first debris sensor 60 may be mounted to the cab 13 and may be on the interior (such as by looking through the windscreen) or exterior (as illustrated) thereof. The second debris sensor 65 may be mounted at or towards the rear of the vehicle 10, such as to the hopper 17 and may be directed downwards towards the road 18.

The control system 40 may comprise at least one debris accumulation sensor 70, 71, 73 configured to generate debris accumulation sensor data for locating debris 9 captured adjacent to the debris collection system 26, particularly that between the debris collection system 26 and the road 18. The debris accumulation sensor data may in particular relate to debris 9 accumulating at the at least one inlet nozzle 15, such as in front of the at least one inlet nozzle 15. In particular, the control system 40 may comprise a plurality of debris accumulation sensors 70, 71, 73 located on each side of the vehicle 10 over a inlet nozzle 15. First and second debris accumulation sensors 70, 71, 73 may be located on the first and second sides of the vehicle 10, or alternatively a plurality of first and second debris accumulation sensors 70, 71, 73 may be located on the first and second sides of the vehicle 10 respectively. The debris 9 may have been captured when the vehicle 10 is moving in the forward direction 7 and optionally when the debris collection system 26, such as the at least one inlet nozzle 15, is adjacent to the road 18.

The at least one debris accumulation sensor 70, 71, 73 may be configured to generate the debris accumulation sensor data relating to at least one debris accumulation scanning area 72 of the road 18, the or each debris accumulation scanning area 72 extending in front of and optionally covering at least a portion of the or each inlet nozzle 15. The debris accumulation sensor data may be for identifying and/or locating debris 9 in the debris accumulation scanning area 72, such as via processing of the debris accumulation sensor data in the controller 41. The at least one debris accumulation scanning area 72 may also extend across at least part of the at least one brush 14 and/or cleaning fluid supplier 32.

The at least one debris accumulation sensor 70, 71, 73 may be mounted to any suitable part of the vehicle 10 and may be directed towards the debris collection system 26, e.g. the at least one inlet nozzle 15, and the debris accumulation scanning area 72 in front of the debris collection system 26, e.g. the at least one inlet nozzle 15. The at least one debris accumulation scanning area 72 may in effect be the view from the at least one debris accumulation sensor 70, 71, 73, covering at least the spatial area around the vehicle 10 where debris 9 may accumulate in front of the debris collection system 26. Such a view would include the road 18 continuously passing under any accumulated debris 9 and the debris collection system 26 as the vehicle 10 moves forward. The at least one debris accumulation sensor 70, 71, 73 may be mounted to the hopper 17, a subframe of the vehicle 10, a body of the vehicle 10, the cab 13 and/or the chassis 19.

The first, second and/or debris accumulation sensors 60, 65, 70, 71, 73 may each comprise at least one camera for capturing an image, such as of the scanning areas 61, 66, 72, and the first, second and debris accumulation sensor data may be image data. The first debris sensor, second debris sensor and/or debris accumulation sensor 60, 65, 70, 71, 73 may comprise at least one of a camera, a 2D image camera, a 3D image camera, a monocular camera, an event camera, an infrared camera, a stereovision camera, lidar and/or a proximity sensor.

The first, second and/or debris accumulation sensors 60, 65, 70, 71, 73 may be configured to provide first, second and/or debris accumulation data from which debris 9 can be identified in front of, behind and/or at the side(s) of the vehicle 10. In the present disclosure, the term “identify” in relation to debris 9 means the determination of the location of such debris 9 on the road 18 (particularly relative to the vehicle 10) and the type of (e.g. physical properties of) the debris 9 on the road 18.

The controller 41 may be configured to receive the first and second debris sensor data from the first and second debris sensors 60, 65 respectively. The controller 41 may be configured to process the first debris sensor data in a debris identification model to identify debris 9 in front of the vehicle 10 and process the second debris sensor data in the debris identification model to identify any debris 9 behind the vehicle 10. The controller 41 may be configured to operate the driving system 16 and/or road cleaning equipment 25 based upon debris 9 identified in front of and behind the vehicle 10 to control the cleaning of debris 9 on the road 18 by the vehicle 10.

By using both the first and second debris sensor data to operate the vehicle 10, the effectiveness of cleaning can be monitored and improved whilst the vehicle 10 is operating. In particular, the first debris sensor data can be used initially to control the driving system 16 and/or road cleaning equipment 25 to collect or clean the debris 9 identified in front of the vehicle 10. The second debris sensor data can be used as feedback to determine the effectiveness of such control by detecting if any debris 9 has been left behind the vehicle 10 and the control of the driving system 16 and/or road cleaning equipment 25 may be adjusted accordingly.

In particular, the controller 41, such as by the processing unit 43, may be configured to process the first and/or second debris sensor data in a debris identification model for identifying the debris 9 on the road 18 in front of and behind the vehicle 10. The debris identification model may be stored on the memory 42. The debris identification model may be updated based upon the first, second and/or debris accumulation data and/or from data communicated to the control system 40 from the remote computer system 50 via the communication system 45.

The debris identification model may comprise any suitable algorithm for identifying and/or classifying debris. The debris identification model may comprise a neural network and may receive the first and/or second debris sensor data (e.g. one or more images of the first and second scanning areas 61, 66), detects objects, including debris 9, and their location from such data and then allocate the objects to one of a plurality of object classifications, including a collect classification indicating that there is debris 9 to be collected. One or more object classification(s) may be collect classification(s) if the object is debris 9, for indicating that the vehicle 10 should clean or collect the debris 9. One or more object classifications may be avoid classification(s), for example if the object is a human, for indicating that the vehicle 10 should avoid the object. There may be a plurality of collect classifications, with each collect classification indicating a certain type of debris 9, such as soft debris 9 (e.g. wrappers and foils) and hard debris 9 (e.g. bricks and stones). One or more object classification(s) may be ignore classification(s) for indicating that the vehicle 10 does not need to take any action (e.g. the surface of the road 18 may be classified as ignore as the vehicle 10 does not need to collect or avoid it).

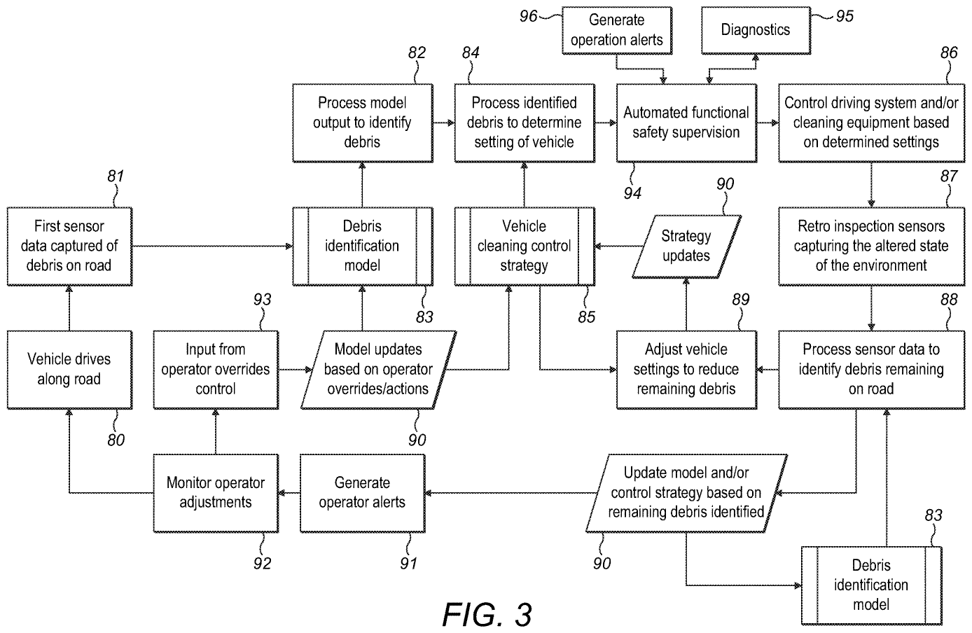

FIG. 3 illustrates a method 79 in accordance with the present disclosure comprising steps the controller 41 is configured to carry out. As the vehicle 10 drives along the road 18 (step 80), the first debris sensor 60 captures first debris sensor data including information relating to any debris 9 on the road 18 in the first scanning area 61 (step 81), which may correspond to a road area 78. The controller 41 receives the first debris sensor data and, via the processing unit 43, processes the first debris sensor data (step 82) using the debris identification model (step 83) to identify the debris 9 in the first scanning area 61. Such identification may include the type and/or location of the debris 9, preferably including which classification the debris 9 falls into (e.g. collect, avoid, ignore). However, such identification may simply be an identification that there is some type of debris 9 present and there may be a control action-or behaviour recommendation associated with such an identification.

The controller 41 may be configured to operate the driving system 16 and/or road cleaning equipment 25 based upon the debris 9 identified in front of the vehicle 10 using a vehicle cleaning control strategy. In particular, the vehicle cleaning control strategy may link the debris 9 identified in front of the vehicle 10 to operational settings of the driving system 16 and/or road cleaning equipment 25. The vehicle cleaning control strategy may be stored on the memory 42. The vehicle cleaning control strategy may be updated based upon the first, second and debris accumulation data and/or from data communicated to the control system 40 from the remote computer system 50 via the communication system 45. The vehicle cleaning control strategy may also link environmental objects (i.e. not debris) around the vehicle 10, such as kerbs, other vehicles, road furniture or the like, which may for example be determined from the first and/or second debris sensor data (e.g. from the same camera image), to operational settings of the driving system 16 and/or road cleaning equipment 25.

As illustrated in FIG. 3, the method 79 may comprise, and the controller 41 may be configured to, process the identified debris 9 (including its type and/or location) (step 84) in the vehicle cleaning control strategy (step 85) to determine the operational settings of the driving system 16 and/or road cleaning equipment 25. The controller 41 may further receive or determine trajectory data indicative of the vehicle 10 trajectory and use such trajectory data during such processing. Subsequently, the controller 41 may control the driving system 16 and/or road cleaning equipment 25 in accordance with the determined operational settings (step 86).

Prior to the control according to the determined operational settings (step 86), an automated functional safety supervision system 94 may perform diagnostics 95 to ensure that they comply with safety parameters, which may be predetermined. If the safety parameters are met or breached, alerts 96 may be generated for the operator such that the operator can take manual control. Alternatively, the vehicle cleaning control strategy may implement an alternative set of operational settings at step 84 until the operation is within the safety parameters.

For example, if the debris 9 is in the avoid classification, the controller 41 may adjust the settings (e.g. machine speed and travel direction) of the driving system 16 so the vehicle 10 drives around the debris 9. If the debris 9 is in the ignore classification, the controller 41 may stop the operation of the road cleaning equipment 25. If the debris 9 is in the collect classification, the controller 41 may control the road cleaning equipment 25 to clean and/or collect the debris 9. In particular, the controller 41 may selectively control the brush system 23, debris collection system 26 and/or cleaning fluid system 30 to clean and/or collect the debris 9 based upon the type and/or location of the identified debris 9. For example, if the brush 14 on the side of the debris 9 of the vehicle 10 may be activated or actuated to clean it. If the debris 9 is PM, the cleaning fluid system 30 may be activated or actuated to wash it. If the debris 9 is suitable for collection, the inlet nozzle 15 on the side of the vehicle 10 of the debris 9 may be activated or actuated to collect it in the hopper 17.

Subsequently, the vehicle 10 continues along the road 18 until the second debris sensor 65 and second scanning area 66 at least partially cover the same road area 78 as initially covered by the first scanning area 66 in step 81. It will be appreciated that such scanning continues repeatedly such that this scanning is repeated continuously, building up a continuous map of debris 9 along the road 18. The method 29 then comprises, at step 87, operating the second debris sensor 65 to capture second debris sensor data indicative of any debris 9 remaining in the second scanning area 66 and/or road area 78.

The second debris sensor data is then processed by the controller 41 (step 88) in the debris identification model (step 83) to identify any debris 9 remaining on the road 18 after the vehicle 10 has passed over the road area 78. The controller 41 may further receive or determine trajectory data indicative of the vehicle 10 trajectory and use such trajectory data during such processing. This provides feedback to enable the improved cleaning by the vehicle 10.

In particular, the controller 41 may be configured to operate the driving system 16 and/or road cleaning equipment 25 based upon the debris 9 identified behind the road cleaning vehicle 10. The controller 41 may adjust the operational settings of the driving system 16 and/or road cleaning equipment 25 (step 89) by using the vehicle cleaning control strategy (step 85) as the vehicle cleaning control strategy may also link debris 9 identified behind the vehicle 10 to the operational settings of the driving system 16 and/or road cleaning equipment 25.

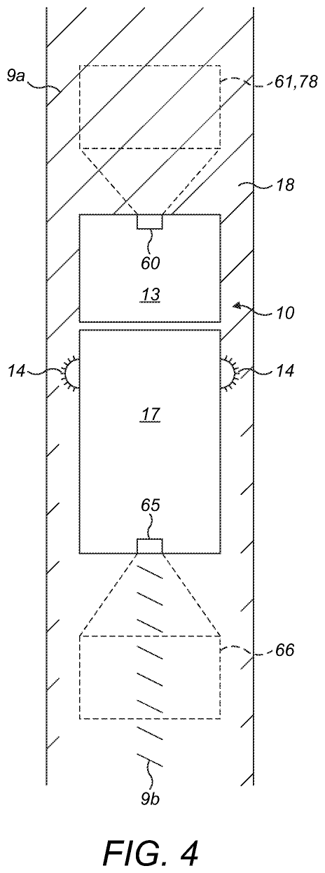

FIG. 4 illustrates a particular embodiment of the present disclosure in which the road cleaning equipment 25 comprises a pair of brushes 14 for cleaning the road 18. In such circumstances, the vehicle 10 may pass over a wide area of debris 9a and the brushes 14 may not completely clean the debris 9a, leaving a strip 9b of uncleaned debris 9b behind the vehicle 10, such as due to the brushes 14 being too far apart. The controller 41 may be configured to, from the debris 9b identified in the second debris sensor 65 data, detect the strip 9b of uncleaned debris along the road 18 resulting from the gap between the brushes 14 from the debris 9b identified behind the vehicle 10. The controller 41 may be configured to, based upon the vehicle cleaning control strategy (step 85), operate the brushes 14 to close the gap between them (step 89) so as to prevent the vehicle 10 from leaving the strip 9b of uncleaned debris.

The controller 41 may also update the vehicle cleaning control strategy and/or debris identification model (step 90) based upon the debris 9 identified behind the vehicle 10. The vehicle cleaning control strategy and/or debris identification model may be updated based upon a comparison of the debris 9 identified in front of and behind the vehicle 10 and/or the operational settings of the cleaning equipment 25 at the time.

In particular, the debris 9 identified behind the vehicle 10 may be used in machine learning to update the vehicle cleaning control strategy and/or debris identification model, such as by operating as new training data for the vehicle cleaning control strategy and/or debris identification model. As a result, in future cleaning operations the road cleaning equipment 25 may be operated in a more efficient manner based upon the learning by the model(s) of the debris 9 left behind the vehicle 10 when the road cleaning equipment 25 was operated in certain circumstances.

The vehicle cleaning control strategy may comprise a machine learning algorithm to update the operational settings of the driving system 16 and/or road cleaning equipment 25 to optimise the future collection of debris 9. The machine learning algorithm may be model-based or model-free and may be a reinforcement learning algorithm. For example, the machine learning algorithm may be a Q-learning algorithm where there are weights and loss functions, which can tune the vehicle cleaning control strategy between exploration (i.e. trying new operational settings) and exploitation (using operational settings from already learnt optimisation). For example, the debris 9 identified behind the vehicle 10 may be classified according to reward levels and those reward levels would be used in the reinforcement learning algorithm to update the operational settings of the driving system 16 and/or road cleaning equipment 25 to optimise the future collection of debris 9.

The method 79 may further comprise the controller 41 generating an alert (step 91) via the alert system 48 to provide information to the operator indicative of the debris 9 left behind the vehicle 10. For example, the alert may be on a display and indicate to the operator that there is still debris 9 being left by the cleaning equipment 25. The controller 41 may determine an alert status based upon the debris 9 identified in front of and/or behind the vehicle 10 and operate the alert system 48 to generate an alert indicative of the alert status for the operator.

The method 79 may further comprise, as in steps 92, 93, the controller 41 monitoring an adjustment of the operational settings of the driving system 16 and/or road cleaning equipment 25 by the operator and subsequently updating the vehicle cleaning control strategy and/or debris identification model based upon the adjustment of the operational settings by the operator. In particular, the debris 9 identified behind the vehicle 10 and adjustment of the operational settings may be used in machine learning to update the vehicle cleaning control strategy and/or debris identification model, such as by operating as new training data for the vehicle cleaning control strategy and/or debris identification model. The vehicle cleaning control strategy may comprise an expert system or Q-learning system using, for example, Convolutional Neural Networks (CNNs) to gain insight from the images and update the strategy for controlling the operational settings accordingly. As a result, in future cleaning operations the road cleaning equipment 25 may be operated in a more efficient manner based upon the learning by the model(s) of how the operator dealt with the debris 9 left behind the vehicle 10 when the road cleaning equipment 25 was operated in certain circumstances.

The vehicle cleaning control strategy may further be adapted based upon the location of the vehicle 10 and debris map data. The debris map data may be representative of debris around a region, such as at least part of an urban area such as a town or city. The debris map data may indicate at least one debris state at or associated with at least one predetermined location. The debris state may comprise the type, amount and/or other properties of debris that is either known to be or has historically been found at the predetermined location. The debris state may be one of a range of values or be part of an index, such as between 0 and 1, with 1 indicating a state of more debris.

Such debris map data may be obtained via vehicles, whether road cleaning vehicles 10 or other types of vehicles, with debris sensors, such as cameras, travelling around the region to assess the debris state and thus generate and store the debris map data. The historical data can be obtained by sequentially obtaining such debris map data in the predetermined locations or areas over a period of time (e.g. at least a week of with a plurality of data collections). For example, by collecting debris map data and identifying debris states a plurality of times over multiple days, weeks and/or months, the debris map data may be indicative of debris collecting on certain streets at certain times (e.g. outside entertainment venues on certain, repetitive mornings of the week). Hence the debris map data may be indicative of predetermined locations or areas that require more or less cleaning by a road cleaning vehicle 10.

The debris map data may be stored in the memory 51 of the remote computer system 50 and communicated to the controller 41 of the vehicle 10. The controller 41 may determine the trajectory and/or location of the vehicle 10, such as via the navigation system 44, so as to spatially locate the vehicle 10 relative to the predetermined locations or areas.

The controller 10 may determine the debris state of an upcoming predetermined location based upon the debris may data and location and/or trajectory of the vehicle 10. The controller 41 may then determine the operational settings of the driving system 16 and/or road cleaning equipment 25 based upon the vehicle cleaning control strategy and the debris state of the upcoming predetermined location. This may be to improve cleaning of the predetermined location. For example, if the debris state indicates that the upcoming predetermined location historically has a significant amount of debris (e.g. a debris state index is close to 1), the road cleaning equipment 25 may be operated at a higher cleaning level than it would have been otherwise. Such control may be implemented by adjusting weightings applied to individual control of parts of the road cleaning equipment 25 in the vehicle cleaning control strategy in accordance with the debris state.

It will be apparent that such a control strategy does not necessarily require the scanning system 59. However, the scanning system 59 may be utilised in the generation of the debris map data by capturing images of the road 18 and debris 9 thereon in use and returning the image data to the remote computer system 50 to build up the debris map data. In addition, preferably the scanning system 59 is utilised with the debris map data to improve control of the vehicle 10 to optimise cleaning.

As a predetermined location enters the first scanning area 61, the controller 41 may compare the captured first debris data with the associated debris map data. In particular, the first debris data may be compared with the debris state so as to assess whether the debris state is accurate. If accurate, the controller 41 may then determine the operational settings based upon the vehicle cleaning control strategy and the debris state. If not accurate, the controller 41 may determine the operational settings based upon the vehicle cleaning control strategy and the first debris data without the debris state. Alternatively, if not accurate, the controller 41 may determine the operational settings based upon the vehicle cleaning control strategy, the first debris data and the debris state, with lower weighting being applied to the debris state than the first debris data when selecting the operational settings. If not accurate, the controller 41 may inform the remote computer system 50, which may update the debris map data on its memory 51.

The effectiveness of cleaning, determined by comparing the first and second debris data, may also be stored for future reference in the debris map data. For example, if it is determined that in a predetermined location the cleaning effectiveness was not sufficient, such as due to more debris than expected being left behind the vehicle 10, the debris state for that predetermined location may be marked and/or changed so as to indicate a higher amount of debris. Such effectiveness of cleaning may then be taken into account by the controller 41 when cleaning the predetermined location in future. In particular, the controller 41 may subsequently determine the operational settings for the predetermined location based upon the vehicle cleaning control strategy and the debris state, including the historical cleaning effectiveness at the predetermined location.

By using the debris map data, operation of the vehicle 10 can be improved by using historical data indicative of where there is a lot of debris to control the vehicle 10 appropriately to ensure that such debris is picked up. Furthermore, the vehicle 10 can capture suitable information to keep the debris map data up-to-date. In addition, if certain areas are particularly hard to clean, this can be captured from the second debris data and then higher cleaning settings can be utilised in future in those areas, thereby improving cleaning.

In an embodiment of the present disclosure, which may be independent of the use of a second debris sensor 65, the controller 41 may be configured to determine the volume and/or mass of debris 9 in front of the vehicle 10 using the first debris sensor data and debris identification model and control the cleaning equipment 25 based upon the determined volume and/or mass of the debris 9 in front of the vehicle 10.

In particular, the controller 41 may be configured to receive first debris sensor data from the first debris sensor 60, process the first debris sensor data in the debris identification model to identify debris 9 in front of the vehicle 10 and estimate the mass and/or volume of the debris 9 in front of the vehicle 10. A plurality of collection classifications of the debris 9 in the debris identification model may have corresponding estimates of masses and/or volumes such that the estimates can be obtained from the first debris sensor data. The controller 41 may allocate debris 9 to such collection classifications. For example, debris 9 in the form of a bottle may be allocated to a certain bottle collection classification having a certain mass and/or volume based upon the measurements of the bottle. If it is not possible to determine whether the debris 9 falls in one of a plurality of suitable classifications, the debris 9 may be allocated to the suitable classification with the highest mass and/or volume. For example, if it cannot be resolved whether a bottle is full or not, it may be allocated to the classification in which it is full and thus has the highest mass—or indeed the mean estimated value calculated from a statistical distribution.

The controller 41 may be configured to operate the driving system 16 and/or road cleaning equipment 25 based upon the estimated mass and/or volume of the debris 9 identified in front of the vehicle 10 to control the cleaning of debris 9 on the road 18 by the vehicle 10.

In particular, the controller 41 may do so using the vehicle cleaning control strategy, which may link the estimated mass and/or volume of the debris 9 identified in front of the vehicle 10 to operational settings of the driving system 16 and/or road cleaning equipment 25.

In a particular embodiment, in which the road cleaning equipment 25 comprises the debris collection system 26 comprising the fan for drawing air and debris through the at least one inlet nozzle 15 adjacent to the road 18, the controller 41 may be configured to operate the fan to control a suction pressure through the at least one inlet nozzle 15 based upon the estimated mass and/or volume of the debris 9 identified in front of the vehicle 10. If the estimated mass and/or volume is relatively high, the fan speed may be relatively increased, whereas if it is relatively low, the fan speed may be relatively decreased.

A classification of mass and/or volume may include an indication of having a relatively low mass to volume ratio (or a mass to volume ratio below a threshold ratio), indicating the presence of significant amounts of PM, or PM above a predetermined PM level. For example, such a classification may be applied if the first debris sensor data is processed and the controller 41 identifies a layer of dust on the road 18. The road cleaning equipment 25 may thus be operated by operating the cleaning fluid system 30, such as above a predetermined fluid supply level, to clean the PM. The fluid suppliers within the debris collection system 26 may in particular be operated above the predetermined fluid supply level to reduce or prevent carry over.

As a result, the operation of the road cleaning equipment 25 can be optimised based upon the physical properties of the debris 9 identified and machine parameters as shown in at least one optimal outcomes, which may be collect the most amount of dust (Particulate Matter PM), have the least amount of carry over back into the target operating theatre, other optimisable parameters include but not limited to noise, fuel rate, fan health and/or water left in the tank/water usage rate. Efficiency is improved as if a relatively low mass and/or volume of debris 9 is identified, the fan power and/or other power requirements of the road cleaning equipment 25 can be reduced to all that is required to clean and/or collect such debris 9.

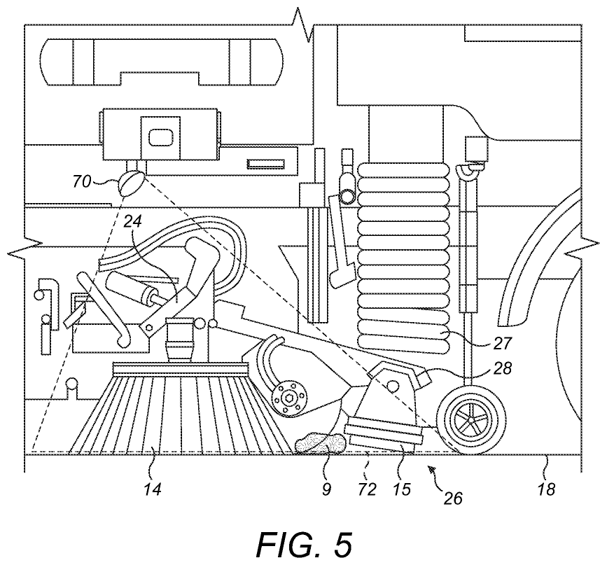

The present disclosure is also, independently or in addition to the inclusion of the first and second debris sensors 60 65, directed to an improved vehicle 10 for detecting and removing blockages in front of the debris collection system 26, such as the at least one inlet nozzle 15. FIG. 5 illustrates the particular issue addressed in which debris 9 becomes caught at the front of the debris collection system 26, such as the at least one inlet nozzle 15, as the vehicle 10 travels along the road 18 in the forward direction 7. In particular, such debris 9 is larger or taller than a gap between the debris collection system 26, such as the at least one inlet nozzle 15, and the road 18. This debris 9 may not be discrete objects but could be an agglomeration of objects compounded over time, due to texture qualities such as coefficient of restitution, stickiness, and mass (for example compounded leaves). This can reduce the effectiveness of the debris collection system 26, particularly the at least one inlet nozzle 15, in collecting debris 9 from the road 18.

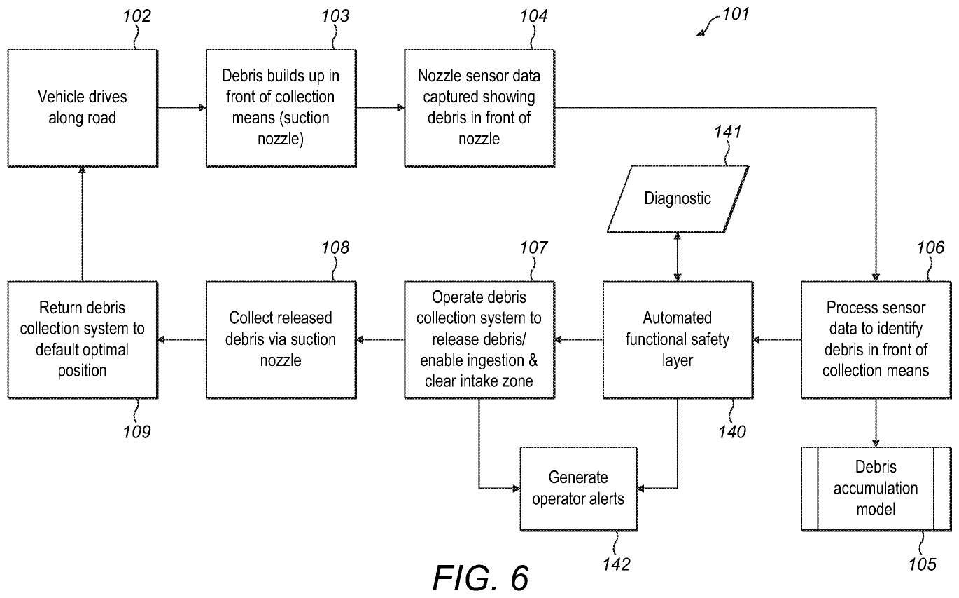

The present disclosure therefore provides the vehicle 10 comprising the controller 41 being configured to perform the steps of the method 101 illustrated in FIG. 6. The vehicle 10 may be driven along a road 18 by the driving system 16 (step 102) and large debris 9 on the road 18 may build up in front of the at least one inlet nozzle 15 (step 103). The at least one debris accumulation sensor 70, 71, 73 may scan the at least one debris accumulation scanning area 72 to generate debris accumulation sensor data indicative of the debris 9 captured in front of the debris collection system 26, such as the at least one inlet nozzle 15 (step 104).

The controller 41 is configured to receive the debris accumulation sensor data from the at least one debris accumulation sensor 70, 71, 73 and process the debris accumulation sensor data (step 106) in a debris accumulation model (step 105) to identify the debris 9 captured in front of the at least one inlet nozzle 15 and/or located in the at least one debris accumulation scanning area 72. The debris accumulation model may be stored on the memory 42. The debris accumulation model may be updated based upon the first, second and debris accumulation data and/or from data communicated to the control system 40 from the remote computer system 50 via the communication system 45. The debris accumulation model may comprise any suitable algorithm, computation and/or neural network.

The controller 41 may provide the debris accumulation sensor data (e.g. one or more images of the at least one debris accumulation scanning area 72) to the debris accumulation model, which detects objects, including debris 9, and their location from such data, and then determine whether the at least one inlet nozzle 15 is obstructed.

The debris accumulation model may identify debris captured in front of the at least one inlet nozzle 15 by (a) determining from the debris accumulation sensor data a rate of change of growth of debris 9 in front of the at least one inlet nozzle 15 and/or (b) determining whether the debris accumulation sensor data shows the road 18 moving relative to the at least one inlet nozzle 15 in an area in front of the at least one inlet nozzle 15, such as the at least one debris accumulation scanning area 72, or whether in the area the road 18 is not visible by being blocked by debris 9 captured in front of the inlet nozzle 15, or where there is no relative motion is present.

The debris accumulation model may be configured as a binary state system which is used to confirm from the debris accumulation sensor data that there is nothing in front of the at least one inlet nozzle 15, thereby confirming that it is not blocked. However, if the debris accumulation model determines any other state, it is considered as being blocked.

In a more preferable arrangement, the debris accumulation model comprises at least one algorithm configured for object detection and classification of debris 9. In particular, using the debris accumulation sensor data the debris accumulation model may be able to track the both a predicted trajectory of the debris 9 in the at least one debris accumulation scanning area 72, as well as the actual trajectory of the debris 9 in the at least one debris accumulation scanning area 72 (e.g. determined from subsequent images). The debris accumulation model may then track the debris 9 relative to the debris collection arrangement 26 so as to determine whether a blockage occurs. Such a model enables blocking to be anticipated as well as improves the accuracy of detecting when blockages occur.

The controller 41 may operate the road cleaning equipment 25 based upon the debris 9 identified in front of the at least one inlet nozzle 15 to release the debris 9 from in front of the at least one inlet nozzle 15 (step 107). Such control may be part of the vehicle cleaning control strategy.

In particular, where the at least one inlet nozzle 15 is configured to be raised from and lowered towards the road 18, the controller 41 is configured to operate the road cleaning equipment 25 based upon the debris 9 identified in front of the at least one inlet nozzle 15 by raising the at least one inlet nozzle 15 from the road 18 such that the debris 9 is released from in front of the at least one inlet nozzle 15. Alternatively, the at least one inlet nozzle 15 may be tiltable fore and aft and the front may be raised and lowered to allow debris 9 to pass into the at least one inlet nozzle 15. Therefore, a gap between the road 18 and at least one inlet nozzle 15 may be adjusted so as to enable debris 9 to be collected by the at least one inlet nozzle 15.

The controller 41 may also be configured to operate the fan and at least one inlet nozzle 15 to draw the debris 9 into the hopper 17 through the at least one inlet nozzle 15 once the debris 9 is released from in front of the at least one inlet nozzle 15 (step 108). In particular, the controller 41 may increase the gap, by tilting or raising, between the at least one inlet nozzle 15 and road 18 to release the debris 9 so as to (a) draw the debris 9 into the hopper 17 through the at least one inlet nozzle 15 and (b) release the debris 9 from in front of the at least one inlet nozzle 15. Simultaneously, the controller 41 may temporarily increase the fan speed and/or power as the at least one inlet nozzle 15 is raised so as to maintain the same volumetric flowrate in spite of the increased gap between the at least one inlet nozzle 15 and road 18.

Prior to the operating the debris collection system 26 to release debris 9 and enable ingestion of the debris 9 (step 107), an automated functional safety supervision system 140 may perform diagnostics 141 to ensure that they comply with safety parameters, which may be predetermined. If the safety parameters are met or breached, alerts 142 may be generated for the operator such that the operator can take manual control. Alternatively, the controller 41 may assess control of the debris collection system 26 according to an alternative set of operational settings at step 106 until the operation is within the safety parameters.

The controller 41 may determine that the debris 9 has been released from in front of the at least one inlet nozzle 15 and subsequently lower and/or tilt the at least one inlet nozzle 15 to reduce the gap with the road 18 for cleaning the road 18 (step 109). The fan speed may also be reduced. In particular, the controller 41 may detect an increase in fan speed as the debris 9 passes through the at least one inlet nozzle 15 and, in response to the detection of the increase in fan speed, lower the at least one inlet nozzle 15 to adjacent the road 18 for cleaning the road 18. Alternatively, the controller 41 may determine that the debris 9 has been released by capturing further debris accumulation sensor data and, via the debris accumulation model, determine that the debris 9 is no longer in front of the at least one inlet nozzle 15.

If the controller 41 determines from the debris accumulation data that further debris 9 is approaching the debris collection system 26 before the gap has been reduced, the gap may be maintained until the further debris 9 has been collected. The fan speed and at least one inlet nozzle 15 may then be returned to their optimal position. Such anticipation of blockages reduces the repetitive ramping up and down of the fan speed and changing size of the gap, avoiding excess fatigue of the components of the vehicle 10.

If the controller 41 determines from the debris accumulation data that the debris 9 continues to block even though the gap between the at least one inlet nozzle 15 and the road 18 has been increased, the controller 41 may further increase the gap between the at least one inlet nozzle 15 and road 18.

Such a method 101 and a vehicle 10 with a controller 41 configured to perform such a method 101 is an effective manner of removing blockages in front of the at least one inlet nozzle 15. It does not rely upon the operator spotting the blockage, such that the blockage can be identified and removed sooner due to its automatic detection and removal via the control system 40. Furthermore, the method 101 avoids the operator leaving the at least one inlet nozzle 15 in the raised position after unblocking by ensuring that the at least one inlet nozzle 15 returns to its lowered position after removal of the blockage. Therefore, continuing effective operation of the debris collection system 26 can be achieved. Furthermore, the cognitive load on the operator may be reduced, thereby improving safety of operation of the vehicle 10.

Further benefits can be achieved by utilising the first and second debris sensor data from the first and second debris sensors 60, 65 in combination with the debris accumulation sensor data from the at least one debris accumulation sensor 70, 71, 73. In particular, debris 9 may be tracked through any coordinate system such as cartesian coordinates of vehicle 10 space (i.e. the area around and including the vehicle 10) by the sensors 60, 65, 70, 71, 73 and the operational settings of the driving system 16 and/or road cleaning equipment 25 monitored. The vehicle cleaning control strategy, debris identification model, and debris accumulation model may also be monitored. Depending upon the effectiveness of cleaning, the vehicle cleaning control strategy may be optimised, such as my machine learning, for future operations.

In particular, the controller 41 may receive the first debris sensor data from the first debris sensor 60 and process the first debris sensor data in the debris identification model to identify debris 9 in front of the vehicle 10. The debris 9 may then be tracked and identified by the at least one debris accumulation sensor 70, 71, 73, when it is subsequently captured in front of the at least one inlet nozzle 15. The debris identification model and/or debris accumulation model may subsequently be updated based upon said debris 9 identified in front of the vehicle 10 and subsequently captured in front of the at least one inlet nozzle 15. For example, the vehicle cleaning control strategy may be updated so that when such debris 9 is identified in future in front of the vehicle 10, specific strategies are implemented to avoid blocking in future (e.g. by raising the at least one inlet nozzle 15 before such debris 9 reaches it, thereby avoiding blocking).

The control system 40 may comprise at least one particulate matter (PM) sensor 75, 76 for generating particle count data indicative of PM concentration(s) in the atmosphere adjacent to the vehicle 10. The at least one PM sensor 75, 76 may be configured to detect a range of sizes of PM, such as PM10, PM2.5 and/or PM1.

The at least one PM sensor 75, 76 may be located on the top of the vehicle 10, such as on the top of the hopper 17 as illustrated. However, preferably the control system 40 comprises a plurality of PM sensors 75, 76 located around the vehicle, such as on its sides, for collecting particle count data around the vehicle 10. For example, at least one PM sensor 75, 76 may be located adjacent to or in proximity of the at least one cleaning brush 14 for capturing particle count data indicative of PM driven into the atmosphere by the at least one cleaning brush 14. A PM sensor 75, 76 may be provided on each side for each of the two cleaning brushes 14 such that it is possible to determine which cleaning brush 14 is driving the PM into the atmosphere.

Preferably, the controller 41 receives a reference PM measurement of the area surrounding the vehicle 10 before it a change that might increase the PMN count.

The reference PM measurement may be provided by at least one PM sensor 75, 76 mounted on the vehicle 10. In particular, a first PM sensor 75 may be located behind, relative to the forward direction of movement of the vehicle 10, at least part of the road cleaning equipment 25, such as the at least one cleaning brush 14, debris collection system 26, an air outlet from the debris collection system 26 (through which carry over may pass) and/or the cleaning fluid system 30. Therefore, the first PM sensor 75 may be located for, and with the aim of, at least partially detecting the PM added to the local atmosphere by the road cleaning equipment 25. There may be a plurality of such located first PM sensors 75. The first PM sensor 75 may be located adjacent the rear of the vehicle 10 and may be mounted by or to the hopper 17.

A second PM sensor 76 may be located in front of, relative to the forward direction of movement of the vehicle 10, at least part of the road cleaning equipment 25, such as the at least one cleaning brush 14 and/or debris collection system 26. The second PM sensor 76 may be located at and/or on the top of or the front of the vehicle 10 so as reduce its exposure to dust blown up by the vehicle 10 itself.

The second PM sensor 76 may be located on or adjacent to the cab 13 as illustrated in FIG. 1. As illustrated, the second PM sensor 76 may be located at or towards the top of the cab 13, and may be located adjacent or near an air intake for the engine of the vehicle 10, which typically extends to the top of the cab 13.

The second PM sensor 76 may be mounted at the front of the vehicle 10 and may in particular be mounted under the front flap 76a or “bonnet” of the vehicle 10. The front flap 76a extends between the front windscreen and bumper and/or bottom edge of the front of the vehicle 10. The second PM sensor 76 may be mounted behind a grille or other air intake through the front flap 76a.

The second PM sensor could be placed near the clean air intake for a radiator and/or a cab clean air intake, for example adjacent a pollen filter. The intake may be under the front flap 76a.

The first and second PM sensors 75, 76 may be located at substantially the same height on the vehicle 10 (i.e. having less than 0.5 m or 1 m height difference therebetween. The second PM sensor 76 may be located on the hopper 17, such as adjacent or at its leading edge, illustrated in FIG. 1 as reference numeral 76b. The first PM sensor 75 may be located on the hopper 17, such as adjacent or at its trailing edge.

A plurality of second PM sensors 76 may be provided at at least two of the aforementioned locations 76, 76a, 76b.

Therefore, the second PM sensor 76 may be located for, and with the aim of, at least partially detecting the PM concentrations of the atmosphere around the vehicle 10 before the road cleaning equipment 25 affects the PM concentrations, particularly whilst the vehicle 10 is moving. Such PM concentrations may be referred to as baseline PM concentrations. There may be a plurality of such located second PM sensors 76. The second PM sensor 76 may be located in front of the first PM sensor 75.

The controller 41 may receive first and second PM data from the first and second PM sensors 75, 76 respectively and may compare the first and second PM data to determine the contribution of the vehicle 10, particularly its road cleaning equipment 25, on PM concentrations around the vehicle 10. Such PM concentration contributions can then be monitored for compliance with industry standards and/or for control of the vehicle 10.

Rather than detecting them on vehicle 10, baseline PM concentrations may be determined from static PM or air quality sensors (not shown) in the local urban environment, which may supply baseline PM concentration data to the remote computer system 50. The baseline PM concentrations may then be communicated to the controller 41 from the remote computer system 50 via the network and communication system 45 (i.e. a V2X system).

Diagnostics or calibration of the vehicle 10 mounted PM sensors 75, 76 may be performed using a V2X system where sensor offset or drift can be tuned within determined error bars to ensure accurate operation by comparing the output data with baseline PM concentrations from static PM or air quality sensors. A diagnostic may alert the control system 40 that a sensor 75, 76 needs service intervention to continue functioning within specified operating parameters.

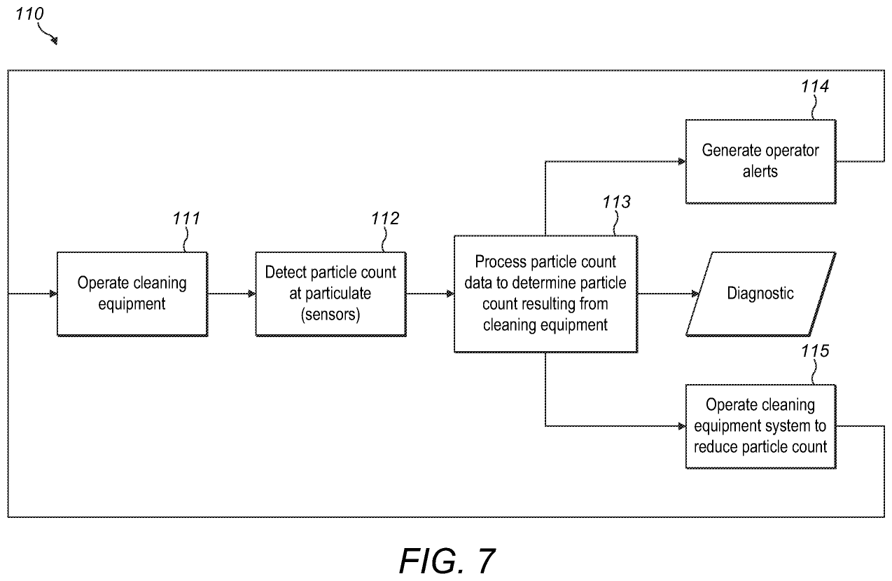

The present disclosure therefore provides the vehicle 10 comprising the controller 41 being configured to perform the steps of the method 110 illustrated in FIG. 7. The vehicle 10 travels along the road 18 and the road cleaning equipment 25 is operated (step 111). The at least one PM sensor 75, 76 may detect the particle count adjacent to the vehicle 10 and provide particle count data to the controller 41 (step 112). Preferably, the first sensor 75 determines PM concentrations downstream or behind at least part of the road cleaning equipment 25.

The controller 41 processes the particle count data to determine atmospheric PM concentration(s) resulting from the operation of the road cleaning equipment 25 (PM concentration contributions, step 113). As discussed above, such PM concentration contributions may be determined from a baseline PM concentration provided from a second PM sensor 76.

The controller 41 may determine if the PM concentrations are caused by the road cleaning equipment 25 and/or is outside of an acceptable range, such as by comparing the PM concentration against a threshold value or range (e.g. an acceptable range of atmospheric PM concentrations) and/or against a historic range (e.g. a range of atmospheric PM concentrations adjacent to the vehicle 10 just before the road cleaning equipment 25 is operated).

The controller 41 may then operate the road cleaning equipment 25 and/or driving system 16 based upon the determined PM concentration(s) (step 115). In particular, the vehicle cleaning control strategy may be adjusted based upon the determined PM concentration(s), particular the PM concentration contributions from the road cleaning equipment 25. Thus, when determining a control strategy to pick up debris 9, the controller 41 may adjust the operational settings of the driving system 16 and/or road cleaning equipment 25 in order to avoid exceeding the PM concentration(s) threshold value or range.

When the PM concentrations are not taken into account in the vehicle cleaning control strategy for picking up debris 9, a range of values may be appropriate for the operational settings to pick up the debris 9, such as the vehicle 10 speed, the fan speed, the height and/or tilt of the at least one inlet nozzle 15, the height and/or rotational speed of the at least one cleaning brush 14 and/or the fluid supply by the cleaning fluid system 30. The operational settings may be set within the appropriate range, with a substantial margin beyond the base operational setting that is deemed to be suitable to pick up the specified debris 9.

However, weightings on different aspects of the control may be adjusted to maintain the PM concentration(s) below a threshold value or range. In particular, weightings may be applied to at least one of the operational settings to reduce the margin beyond the base operational setting. Thus, for example, the fan speed may be reduced compared to the standard control strategy to avoid increase PM emissions during carry over, but maintained above the minimum fan speed for picking up the debris 9.

In particular, the controller 41 may adjust the operation of the cleaning fluid system 30 to supply additional cleaning fluid 31 to the road 18 if the atmospheric PM concentrations reach or exceed the threshold value or range. In particular, the amount of cleaning fluid 31 applied may usually be maintained within a predetermined fluid application rate or application period in order to avoid running out of cleaning fluid 31 over a specified operational time period of the vehicle 10. For example, cleaning fluid 31 may be applied at a suitable application rate or period to ensure the vehicle 10 can be kept operational for a time period of at least one hour. However, if the PM concentrations reach or excess the threshold value or range, the vehicle cleaning control strategy may overrule such a cleaning fluid 31 retention strategy and instead increase the application rate or period above a sustainable level in order to reduce PM concentrations.

Increasing the application of cleaning fluid 31 may be particularly effective when the cleaning fluid 31 is supplied to the road 18 at or adjacent to the at least one brush 14, supplied at the front of the vehicle and/or at or adjacent to the at least one inlet nozzle 15 and/or within the at least one inlet nozzle 15. The cleaning fluid 31 may capture the PM thrown up by the at least one brush 14 and/or at least one inlet nozzle 15 to reduce PM concentrations caused by the vehicle 10.

The controller 41 may operate the alert system 48 to alert the operator to the determined atmospheric PM concentration(s). In particular, the controller 41 may alert the operator if the atmospheric PM concentrations reach or exceed the threshold value or range.

Further benefits can be achieved by utilising the first, second and/or debris accumulation sensor data from the first, second and/or debris accumulation sensors 60, 65, 70, 71, 73 in combination with the particle count data from the at least one PM sensor 75. The controller 41 may process the first debris sensor data in the debris identification model to identify PM debris 9 in front of the vehicle 10 and operate the cleaning fluid system 35 to direct cleaning fluid 31 onto the road 18 to capture the PM debris 9. Therefore, the generation of high PM concentrations can be pre-empted and avoided. As a result, the vehicle 10 in effect receives an “early warning” from the vision systems, when previously encountered objects with similar identifiable and classifiable characteristics generated a large amount of airborne particulates. The system can be pre-emptively dampened, turning on additional water, lowering fan speeds and slowing brushes down to minimise the effects.

1. A road cleaning vehicle comprising:
a driving system for driving the road cleaning vehicle along a road having debris thereon;
road cleaning equipment for cleaning the debris on the road; and
a control system comprising:
at least one debris sensor, the at least one debris sensor comprising at least one image camera configured for generating first debris sensor image data for locating debris on the road in front of the road cleaning vehicle and second debris sensor image data for locating debris on the road behind the road cleaning vehicle; and
a controller configured to:
receive first and second debris sensor image data from the at least one debris sensor;
process the first debris sensor image data in a debris identification model to identify the location and type of debris in front of the road cleaning vehicle and process the second debris sensor image data in the debris identification model to identify the location and type of debris behind the road cleaning vehicle; and
operate the driving system and/or road cleaning equipment based upon the location and type of debris identified in front of and behind the road cleaning vehicle to control the cleaning of debris on the road by the road cleaning vehicle.

2. The road cleaning vehicle of claim 1 wherein the controller is configured to:
process the first debris sensor image data in a debris identification model to identify debris in front of the road cleaning vehicle;
operate the driving system and/or road cleaning equipment based upon debris identified in front of the road cleaning vehicle to control the cleaning of debris on the road by the road cleaning vehicle;
process the second debris sensor image data in the debris identification model to identify debris behind of the road cleaning vehicle; and
operate the driving system and/or road cleaning equipment based upon the debris identified behind the road cleaning vehicle to control the cleaning of debris on the road by the road cleaning vehicle.

3. The road cleaning vehicle of claim 1 wherein the at least one debris sensor comprises a first debris sensor configured for generating first debris sensor image data for locating debris on the road in front of the road cleaning vehicle and a second debris sensor configured for generating second debris sensor image data for locating debris on the road behind the road cleaning vehicle

4. The road cleaning vehicle of claim 1 wherein the controller is configured to operate the driving system and/or road cleaning equipment based upon the debris identified in front of the road cleaning vehicle using a vehicle cleaning control strategy.

5. The road cleaning vehicle of claim 4 wherein the controller is configured to operate the driving system and/or road cleaning equipment, using the vehicle cleaning control strategy, also based upon the location of the vehicle and debris map data, environmental objects around the vehicle and/or a determined trajectory of the vehicle.

6. The road cleaning vehicle of claim 4 wherein the controller is configured to operate the driving system and/or road cleaning equipment based upon the debris identified behind the road cleaning vehicle by:
using the vehicle cleaning control strategy; and/or
updating the vehicle cleaning control strategy and/or debris identification model based upon the debris identified behind the road cleaning vehicle.

7. The road cleaning vehicle of claim 6 wherein the vehicle cleaning control strategy and/or debris identification model is updated based upon a comparison of the debris identified in front of and behind the road cleaning vehicle.

8. The road cleaning vehicle of claim 1 wherein the road cleaning vehicle further comprises an alert system for providing information to an operator and the controller is further configured to:
determine an alert status based upon the debris identified in front of and behind the road cleaning vehicle; and
operate the alert system to generate an alert indicative of the alert status for the operator.

9. The road cleaning vehicle of claim 1 wherein the controller is configured to-monitor an adjustment of the operational settings of the driving system and/or road cleaning equipment by an operator and subsequently update the debris identification model based upon the adjustment of the operational settings by the operator.

10. The road cleaning vehicle of claim 1 wherein the debris identification model is configured to receive the first and/or second sensor image data, detect debris and the location of such debris from the first and/or second sensor image data and allocate the debris into one of a plurality of objection classifications, including a collect classification indicating that there is debris to be collected.

11. The road cleaning vehicle as claimed in claim 10 wherein:
one or more object classifications is an avoid classification, for indicating that the vehicle should avoid the debris, wherein if the debris is in the avoid classification, the controller adjusts the driving system so the vehicle drives around the debris; and/or
one or more object classifications is an ignore classification, for indicating that the vehicle does not need to take any action, wherein if the debris is in the ignore classification, the controller stops operating of the road cleaning equipment.

12. The road cleaning vehicle of any claim 3 wherein the first debris sensor is configured to capture sensor image data for locating debris in a first scanning area of the road in front of the vehicle and the second debris sensor is configured to capture sensor image data for locating debris in a second scanning area of the road behind the road cleaning vehicle.

13. The road cleaning vehicle of claim 3 wherein the road cleaning vehicle comprises a cab and the first debris sensor is mounted to, adjacent to or in the cab and/or the road cleaning vehicle comprises a hopper and the second debris sensor is mounted to, adjacent to or in the hopper.

14. The road cleaning vehicle of claim 1 wherein the road cleaning equipment comprises at least a pair of brushes for cleaning the road and the controller is configured to:
process the second debris sensor image data in the debris identification model to identify a line of uncleaned debris along the road behind the vehicle resulting from a gap between the brushes from the debris identified behind the road cleaning vehicle; and
operate the driving system and/or road cleaning equipment based upon debris identified in front of and behind the road cleaning vehicle to control the cleaning of debris on the road by the road cleaning vehicle by operating at least the pair of brushes to close the gap between them so as to prevent the road cleaning vehicle from leaving the line of uncleaned debris.

15. A method of operating a road cleaning vehicle of claim 1 comprising, at the controller:
receiving the first and second debris sensor image data from the at least one debris sensor;
processing the first debris sensor image data in a debris identification model to identify debris in front of the road cleaning vehicle and process the second debris sensor image data in the debris identification model to identify any debris behind the road cleaning vehicle; and
operating the driving system and/or road cleaning equipment based upon the debris identified in front of and behind the road cleaning vehicle to control the cleaning of debris on the road by the road cleaning vehicle.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A road cleaning vehicle comprising:
a driving system for driving the road cleaning vehicle along a road having debris thereon;
a road cleaning equipment for cleaning the debris on the road; and
a control system comprising:
a first PM sensor located behind, relative to the forward direction of movement of the vehicle, at least part of the road cleaning equipment, for generating first PM data indicative of PM concentrations in the atmosphere including those resulting from the operation of the road cleaning equipment; and
a second PM sensor located at and/or on the top of or the front of the vehicle and located in front of, relative to the forward direction of movement of the vehicle, at least part of the road cleaning equipment, for generating second PM data indicative of PM concentrations in the atmosphere prior to any PM concentration contributions from the road cleaning equipment; and
a controller configured to:
receive the first and second PM data from the first and second PM sensor; and
process the first and second PM data to determine atmospheric PM concentrations resulting from the operation of the road cleaning equipment by comparing PM concentrations determined by the first PM sensor with PM concentrations determined by the second PM sensor.

35. The road cleaning vehicle of claim 34 wherein the controller is configured to, based upon the determined atmospheric PM concentrations resulting from the operation of the road cleaning equipment, operate the road cleaning equipment and/or driving system based upon the determined atmospheric PM concentrations and/or operate an alert system of the road cleaning vehicle to alert the operator to the determined atmospheric PM concentrations.

36. The road cleaning vehicle of claim 34 wherein the control system comprises at least one debris sensor configured to locate debris on the road in front of and/or behind the road cleaning vehicle when moving in the forward direction and the controller is configured to:
receive debris sensor data from the at least one debris sensor;
process the debris sensor data in a debris identification model to identify PM debris in front of and/or behind the road cleaning vehicle; and
operate the driving system and/or road cleaning equipment, in accordance with a vehicle cleaning control strategy, based upon PM debris identified in front of and/or behind the road cleaning vehicle to capture the PM debris.

37. A method of operating the road cleaning vehicle of claim 34 comprising:
operating the road cleaning vehicle to move in a forward direction with the first PM sensor located behind at least part of the road cleaning equipment and with the second PM sensor located in front of at least part of the road cleaning equipment;
by the first PM sensor, generating first PM data indicative of PM concentrations in the atmosphere including those resulting from the operation of the road cleaning equipment;
by the second PM sensor, generating second PM data indicative of PM concentrations in the atmosphere prior to any PM concentration contributions from the road cleaning equipment; and
by the controller:
receiving the first and second PM data from the first and second PM sensor; and
processing the first and second PM data to determine atmospheric PM concentrations resulting from the operation of the road cleaning equipment by comparing PM concentrations determined by the first PM sensor with PM concentrations determined by the second PM sensor.

38. A road cleaning vehicle comprising:
a driving system for driving the road cleaning vehicle along a road having debris thereon;
road cleaning equipment for cleaning the debris on the road;
a navigation system for determining a spatial location of the vehicle; and
a control system comprising a controller configured to:
determine the location and/or trajectory of the vehicle via the navigation system;
receive debris map data indicative of at least one debris state associated with at least one predetermined location;
determine from the location and/or trajectory and the debris map data that the vehicle is approaching and/or is at least partially in the at least one predetermined location; and
operate the driving system and/or road cleaning equipment, as the vehicle travels at least partially over the at least one predetermined location, based upon the at least one debris state associated with the at least one predetermined location.

39. A method of operating the road cleaning vehicle according to claim 38 comprising, at the controller:
determining the location and/or trajectory of the vehicle via the navigation system;
receiving debris map data indicative of at least one debris state associated with at least one predetermined location;
determining from the location and/or trajectory and the debris map data that the vehicle is approaching and/or is at least partially in the at least one predetermined location; and
operating the driving system and/or road cleaning equipment, as the vehicle travels at least partially over the at least one predetermined location, based upon the at least one debris state associated with the at least one predetermined location.
